(19) United States
(12) Patent Application Publication
(10) Pub. No.: US 2009/0000574 A1
(43) Pub. Date: Jan. 1, 2009

(54) Organic Hydride Reactor and Hydrogen Generator

(75) Inventors: Masatoshi Sugimasa, Tokai (JP); Akiyoshi Komura, Hitachi (JP); Takao Ishikawa, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi, Ltd.

(21) Appl. No.: 12/146,494

(22) Filed: Jun. 26, 2008

(30) Foreign Application Priority Data
Jun. 29, 2007 (JP) 2007-171410

(51) Int. Cl. H01M 8/18

(52) U.S. Cl. 123/3; 429/21

(57) ABSTRACT

An organic hydride reactor generates hydrogen by electrolyzing electrolyte to manufacture the organic hydride from the generated hydrogen. The system has a anode and cathode opposed to each other, the electrolyte supplied between the anode and cathode, a hydrogenation catalyst performing hydrogenation reaction between the hydrogen supplied from the anode by electrolysis and organic compound. The anode cathode has gas-fluid separation function and the electrolyte is supplied to only one surface of the anode and cathode, and a gas caused by electrolysis is discharged from a surface not being in contact with the electrolyte of the anode and cathode.

This application claims priority from Japanese application serial No. 2007-171410, filed on Jun. 29, 2007, the content of which is hereby incorporated by reference into this application.

### BACKGROUND

The present invention relates to an organic hydride reactor, and a hydrogen generator, particularly to a system for producing organic hydride from hydrogen generated by electrolysis, and a distributed power source and an automobile using it.

As a result of continuing to dissipate great many quantity of fossil fuel, earth warming, climate change, and city area air pollution due to carbon dioxides have been getting more and more serious and therefore, recently hydrogen has attracted special interest as next generation energy in place of the fossil fuel. The hydrogen discharges only water after burning and is capable of being generated through electrolysis using natural energies such as solar cell power and wind power. Accordingly, it is a clean energy source, because of discharging only a small quantity of environment pollution substances in manufacturing and using itself.

Also, relating to generation of the hydrogen, steam reformation of the fossil fuel is most popular and many other processes such as by-product hydrogen in manufacturing iron and soda, pyrolysis reaction, photo catalyst reaction, microorganism reaction and water electrolysis reaction have been disclosed. Especially, since power necessary for the water electrolysis can be supplied from various sources, the hydrogen has lately attracted attention as an energy source which does not depend on specific regions.

On the other hand, transportation, storage and supply system for the hydrogen as a fuel have been needed to make special considerations to ensure enough safety. Since the hydrogen is in gas state at the room temperature, it is difficult to easily transport and storage the hydrogen comparing with ordinary liquids and solid materials. In addition, the hydrogen is flammable material and easy to be explosive when appropriate rate of air to the hydrogen is satisfied.

As a power generation technique solving such problems, a generation system is disclosed in Japanese laid open patent publication 7-192746 in which steam is added to hydrocarbon fuel to generate hydrogen, and then the hydrogen is stored in a hydrogen absorbing alloy, and at starting, the hydrogen is taken out from the hydrogen absorbing alloy and added to the hydrocarbons to be hydrodesulfurized and the resulting hydrogen is supplied to fuel cells.

Recently, as a way of the hydrogen storage superior to other ones from safety, portability and storability of view, a hydrocarbon organic hydrideystem using hydrocarbons such as cyclohexane, dekalin has been focused. These hydrocarbons are liquid state at the room temperature and have good transportability.

For example, benzene and cycloxysane are cyclic hydrocarbon having same carbon number; the benzene is unsaturated hydrocarbon having double bond of carbons; on the other hand, cycloxysane is saturated hydrocarbon having non-double bond. The cycloheysane is obtained through a hydrogenation reaction to benzene, and the benzene is obtained through a dehydrogenation reaction to the cyclohexysane. That is, hydrogen storage and release are realized through using hydrogenation and dehydrogenation of these hydrocarbons.

### SUMMARY

The hydrogen generated by the water electrolysis has advantages that there is no limitation on the place for the hydrogen generating facility system, and efficiency variation depending on a scale of the facility is small, if the electric power is supplied to the facility adequately. At present, as ways of generating hydrogen using electrolyte, there are processes using alkaline solution and solid polymer membrane as each electrolyte. These ways have a general trend of high cost relative to efficiency.

The organic hydride are desirable to be reused by hydrogenating namely adding hydrogen after use because raw material of the organic hydride is fossil fuel. However, in the case of producing cyclohexane by hydrogenating to benzene, a problem comes out on storing and transporting the hydrogen to be used for hydrogenation. If a hydrogenation facility is constructed neighboring to the hydrogen producing system, the problems may be solved. However, new problems on the construction and operation cost appear and as a result, total energy efficiency also reduces. Additionally, the large scale facility limits the place to be constructed. Therefore, a unified system is required to be capable of hydrogenating to the organic hydride with a compact size and high efficiency after use.

An object of the present invention is to provide a compact and high efficiency organic hydride reactor, distributed power source and an automobile using it, that are presumed as the next generation energy supply infrastructure.

An organic hydride reactor of the present invention is configured basically as follows.

The organic hydride reactor for generating hydrogen by electrolysis of an electrolyte and producing organic hydride from the generated hydrogen, comprises an anode (fuel electrode) and a cathode (oxygen electrode) for electrolysis, the electrolyte applied between the anode and cathode, and a hydrogenation catalyst for performing a hydrogenation reaction between the hydrogen supplied by electrolysis from the anode and an organic compound.

The anode and cathode have a gas-fluid separation function. The electrolyte is supplied to only one surface of the anode and cathode. Gases generated by the electrolysis are discharged from surfaces of the anode and cathode which are not in contact with the electrolyte.

Additionally, the hydrogenation catalyst may be formed at the surface from which the hydrogen is discharged.

Such a hydrogen or organic hydrogen reactor enables to store hydrogen and supply it to a distributed power source, such as automobiles or consumer fuel cells, with compact design and high efficiency. Additionally, it can establish the safety of generating, transporting, and storing the hydrogen in the hydrogen society.

### BRIEF DESCRIPTION OF DRAWINGS

FIG. 1 is a schematic view showing an organic hydride reactor of an embodiment as to the present invention;

FIG. 2 is a schematic view showing a anode of the embodiment; and

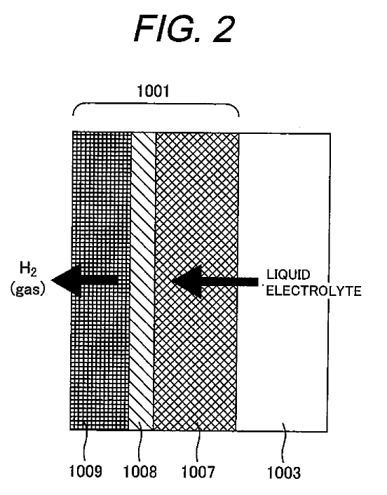

FIG. 3 is a schematic view showing a hydrogen storing and supplying system.

### DESCRIPTION OF THE PREFERRED EMBODIMENTS

The embodiment of the present invention relates to an organic hydride reactor for generating hydrogen using electrolysis and for hydrogenating an organic compound which repeats chemically storing and discharging the hydrogen. In the organic hydride reactor, an electrolyte is supplied between an anode and a cathode arranged in opposition to each other. Each of the anode and cathode has a surface being in contact with the electrolyte and a surface being exposed in gaseous atmosphere (not being in contact with the liquid electrolyte), and has a gas-fluid separation function. The hydrogen generator part in the reactor issues hydrogen generated from the anode-surface side being exposed in gaseous atmosphere, by electrolyzing the liquid electrolyte at the anode-surface side being in contacted with the liquid electrolyte. Both hydrogen generation and hydrogenation reaction to the organic compound are simultaneously performed with both sides of the anode, by electrolysis and flowing the organic compound, which stores and releases hydrogen chemically and repeatedly, through the anode-surface side being exposed in the gaseous atmosphere.

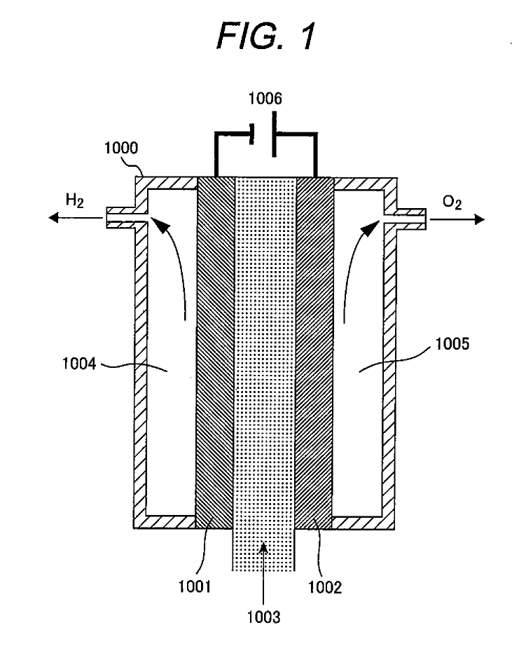

FIG. 1 is a schematic view showing an organic hydride reactor as to an embodiment of the present invention. The organic hydride reactor has the anode 1001 and cathode 1002 disposed in opposition to each other and hydrogen is generated through electrolysis of a liquid electrolyte 1003 supplied between the anode 1001 and cathode 1002.

The liquid electrolyte 1003 is supplied to only a surface where a couple of the anode 1001 and cathode 1002 are opposed to each other, and a hydrogen chamber 1004 and an oxygen chamber 1005 are disposed at the reverse side surface of the anode 1001 and cathode 1002, and both of the hydrogen and oxygen gas generated by the electrolysis are discharged from these surfaces respectively.

Here, the anode 1001 and cathode 1002 have a gas-fluid separation function. Fi.2 is a partially enlarged schematic view showing the anode 1001 and a boundary portion of the liquid electrolyte 1003. The anode 1001 forms three layered construction and comprises a hydrophilic layer 1007 having a surface being in contact with the liquid electrolyte, hydrophobic layer 1009 having a surface being in contact with gas, and a catalyst layer 1008 positioned between the layers.

The hydrophilic layer 1007 and hydrophobic layer 1009 have fine spaces such a porous structure through which allow the liquid electrolyte 1003 or gas to pass, and the size of each fine space is selected as about 1 nm˜10 μm to prevent the liquid electrolyte 1003 out of the hydrophobic layer 109 from leaking. Therefore, the liquid electrolyte 1003 passing through the hydrophilic layer 1007 builds up in the catalyst layer 1008. The cathode 1002 has the same structure as that of the anode 1001. When a predetermined voltage is applied between the anode and cathode, the liquid electrolyte is electrolyzed at the surface of the catalyst layer 1008 and hydrogen and oxygen gases are generated respectively. In the case of that the hydrogen generator is an alkali water electrolysis type, conventionally, the generated gases would cover the surfaces of the anode and cathode with babbles of the gases. The resulting would bring to lack of the liquid electrolyte supply for the anode and cathode, and thereby the current density would not raise, as a result, the efficiency is also degraded. However, according to the structure of the present embodiment, the each generated gas flows quickly to the hydrophobic layer, and no bubbles build up on the surface of each of the anode and cathode being in contact with the liquid electrolyte. Accordingly, the current density rises up. Since the cathode has the same structure as that of the anode, no bubbles also have influence on the cathode. Therefore, the embodiment can obtain the higher current density as compared with an oxygen generating system of a solid electrolysis type which causes babbles at the cathode. Furthermore, provided that low cost alkaline solution is used as a liquid electrolyte, the material cost becomes lower than the electrolyte of solid high molecular type.

The organic hydride reactor of the embodiment supplies hydrogen generated by this hydrogen generator to the hydrogenation catalyst and produces the organic hydride by the hydrogenation reaction between the organic compound and hydrogen. While the hydrogenation catalyst is able to be set outside or inside of the hydrogen chamber 1004, from a viewpoint of high efficiency of the system and its miniaturization, it is desirable to put inside the hydrogen chamber 1004. The hydrogen generator part as shown in FIG. 1, it is able to operate at the high temperature over 100 degrees C. by using a high temperature-resistant electrolyte, such as a highly concentrated alkaline solution. While the water electrolysis reaction is prone have a large reaction overvoltage, the overvoltage decreases at the high temperature and the reaction speed as well as the reaction efficiency also becomes high.

In addition, at operation temperature 200-300 degree C., the temperature becomes appropriate value to enable hydrogenation reaction to the aromatic group series organic compound, such as benzene and toluene. Accordingly, provided that the hydrogenation catalyst is formed on the hydrogen generating surface of the anode, it can produce the organic hydride efficiently together with the hydrogen generation.

Giving a concrete example, the hydrogenation catalyst is provided on the hydrophobic layer of the utmost outside layer in the anode 1001. In such a structure, when flowing the aromatic group series organic compound such as benzene and toluene in the hydrogen chamber, hydrogen generated by electrolysis reacts with speed by hydrogenation catalyst on the hydrophobic layer to produce the organic hydride. In the organic hydride reactor of the embodiment, at both surface of the anode, the generation of the hydrogen and the hydrogenation to the organic compound are performed instantaneously, and as a result, the reactor can become smaller. Also, as the respective pure hydrogen and the organic compound are contact with each other at only the surface of the hydrogenation catalyst on the hydrophobic layer, which is reaction field, the waste material reduces and the hydrogenation reaction progresses efficiently. Moreover, as current conduction for electrolysis and hydrogenation reaction result in causing heat, the necessity of heating can reduce to the minimum, and its whole energy efficiency rises up, too.

For the hydrogenation, at least one of benzene, toluene, xylene, mesitylene, naphthalene, methylnaphthalene, anthracene, biphenyl, phenanthreneand and their alkyl substitution or combination of the plural materials are available and any of these alkyl or combination of them may be usable. These whole catalysts are called as organic hydride. These organic hydride can store hydrogen by hydrogenation where the hydrogen is added to carbon double bond. With respect to the catalysts used for the hydrogenation reaction of organic hydride, materials having been already developed and well known are also available and practical. In the embodiment, the hydrogenation is desired to perform at lower temperature to improve the whole system efficiency.

In addition, well-known catalysts are useable as the catalyst for water electrolysis. Especially, when the liquid electrolyte is alkaline, metals except for expensive platinum group metals, for example, nickel, silver, and iron are available and they are able to realize low cost.

The material and manufacturing procedures for the organic hydride reactor and hydrogen generator are explained below.

Each of the anode and cathode has a three-layer structure and each layer includes fine spaces such as porous so as to allow the liquid electrolyte and generated gas to pass through. The size of each fine space is desired to be 1 nm˜10 μm to suppress leakage of the liquid electrolyte from a hydrophobic layer or entering for the generated gas into a hydrophilic layer. The shape of each layer is not limited and porous material, mesh, non-woven fabric and woven fabric are available, if the layer are able to be arranged in opposition to each other.

The catalyst layer plays an important role to determine quantity of overvoltage and current density in electrolysis. A catalyst material used as the catalyst is metal, for example, Ni, Pd, Pt, Rh, Ir, Re, Ru, Co, Fe, Ag and the alloy of these metals. In particular, Ni and Ag are most appropriate from a viewpoint of the cost provided that the liquid electrolyte is alkaline or neutral. The manufacturing methods for the catalyst material are, for example, plating, coprecipitation method, thermal decomposition method, and they are not limited particularly. With respect to the shape, all it has to do is passes through the liquid electrolyte and generated gas, mesh and porous material are suitable. Also, for improving the current density, large surface area is preferable. Therefore, the manufacturing method, such as making of fine particles, supporting carriers and porous plating are preferable.

The hydrophilic layer requires characteristics to pass the liquid electrolyte up to catalyst layer and not to pass the gas generated at the catalyst layer. Therefore, as to each of the fine spaces in the hydrophilic layer, the size of about 1 nm˜10 μm is required inside the layer. Polymer including hydrophobic group such as sulfonic group and carboxyl group, a carbon material provided with modification of hydroxyl group on the surface thereof and metal oxide material.

These are able to be used with combination, in particular, a way of forming the hydrophilic layer from at least one of the carbon material such as activated charcoal and metal oxide material of fine particles 1˜1000 μm using the polymer as a binder, is preferable to form easily the hydrophilic layer which has fine spaces for passing through the liquid electrolyte. Of course, other ways of forming the layer are available and porous materials, meshed carbon compounds and metal oxides are available. Also, meshes, porous materials, non-woven fabrics and woven fabrics of above explained polymers are available, and the polymer is available to be painted on the mesh of other materials.

The hydrophobic layer requires characteristics which prevents the liquid electrolyte from leaking out and can discharge the gas generated at the catalyst layer to the outside. Therefore, as to each of the fine spaces in the hydrophobic layer, the size of about 1 nm˜10 μm is required inside the layer. Carbon materials such as the graphite or the like free from a substitution group on the surface thereof, or polymer including hydrophobic group such as alkyl group and fluorine group are preferable as a material of the hydrophobic layer. A way of forming the hydrophobic layer from fine particles of carbon material using hydrophobic polymer such as politetra fuluoroethylene (PTFE) as a binder, is the easiest way. The way has been already generalized as a gas diffusion electrode forming technique for fuel cells. Also, mesh, non-woven fabric, woven fabric, sheet, and paper formed from carbon fiber and porous material is available; and also mesh, non-woven fabric, woven fabric formed from hydrophobic polymer is available.

While the anode 1001 and cathode 1002 of the embodiment comprises thee layer structure of a hydrophilic layer 1007, catalyst layer 1008, and hydrophobic layer 1009, it is preferable to form respective layers separately and then laminate them, or to form each of them on an earlier-formed layer to stratify them one by one. Each thickness of the anode and cathode is not limited. As current collector to conduct current, film, mesh and wire of metal materials, such as Al and Ni are available to dispose to the catalyst layer. When carbon materials are used as a hydrophobic layer and hydrophilic layer, the current collector is preferable to be arranged in the most outside layer or the most inner side layer. Or the hydrophobic layer and hydrophilic layer may be used itself as a current collector.

In the above-mentioned embodiment, in place of the liquid type electrolyte existing between the anode and cathode, a solid type electrolyte and gel type electrolyte are available, and however, the liquid electrolyte is more preferable from a viewpoint of cost, electric conductivity, high temperature responsibility over 100. For example, alkali solutions such as sodium hydroxide and potassium hydroxide, ion liquid, and molten salt are preferable. Especially, alkali solution including potassium hydroxide or sodium hydroxide 1˜90 weight % is most preferable from a view point of low cost and high conductivity.

However, the alkali solution forms carbonate under the presence of dioxide carbon in the air and may decrease performance of the electrolyte due to the carbonate. Therefore, it requires to lessen contact with the air or re-circulate electrolyte liquid itself. In addition, it is preferable to narrow the gap between the anode and cathode and supply the liquid electrolyte using capillary action or supply the liquid electrolyte to the hydrophilic layer by absorption.

The organic hydride reactor of the embodiment can produce hydrogen and organic hydride respectively at both sides of one sheet of the anode by supporting the hydrogenation catalyst at hydrophobic portion in the anode. These processes are able to realize to minimize the organic hydride reactor/hydrogen generator and improve the producing efficiency of the hydrogen and organic hydride.

As the hydrogenation catalysts, metals, for example, Ni, Pd, Pt, Rh, Ir, Re, Ru, Mo, W, V, Os, Cr, Co, Fe or the like, and alloy of these are available. The hydrogenation catalysts are preferable to make it corpuscular to achieve low cost by decreasing the catalyst metal while increasing reaction surface area. Also, the hydrogenation catalyst is desirable to be supported on the carrier to prevent increasing of specific surface area due to condensation of fine particles. The manufacturing method of the catalyst is not limited particularly to coprecipitation method, pyrolysis method, electroless plating are available. As catalyst supporting materials (carrier), any of activated charcoal, carbon nano-tube, and graphite, which is applied to the hydrophobic layer, is usable in the as-is status. In place of those materials, alumina silicate such as silica, alumina and zeolite may be available.

The operation of hydrogen and organic hydride reactor in accordance with the present invention is preferable to perform at the temperature over 100 degrees C. In the case of the hydrogen generator, while the operation is possible at the room temperature, it is preferable to operate at region of about 100˜200 degrees C. to decrease over-voltage necessary for the water decomposition and increase energy efficiency operation.

In the case of the organic hydride reactor, the operation is desirable at the temperature region about 200˜400 degrees C. which goes on the hydrogenation reaction at the practical speed. When using an alkaline solution such as sodium hydroxides and potassium hydroxides as the liquid electrolyte, or when operating at the temperature over 100 degrees C., the concentration of sodium hydroxide and potassium hydroxides should be increase to 50˜90 weight %.

When performing high temperature operation, it is desired to maintain pressure within the reactor to 1˜30 atm to prevent vaporization of the liquid electrolyte. In the case of the hydrogen generator, since the pressure inside thereof becomes high when the hydrogen is stored, an exclusive apparatus for high-pressurizing inside the generator is not necessary and results in advantage with cost.

In the case of using directly in the internal combustion engine or a boiler, since it is possible to feed a large mount of hydrogen to be used, there is an advantage to make high output in the internal combustion engine. Method for raising the pressure inside the reactor is injecting an inertia gas such as nitrogen gas and helium gas or sealing the gas generated through electrolysis up to a constant pressure.

In generating hydrogen by electrolysis, there is no limitation for necessary electric power source. A system power source and direct power from nuclear power stations and thermal power stations are available. If enabling to use solar cells, wind power and water power, hydrogen generation is possible without discharging dioxide carbons. Also, the power stored in a battery is available. A nuclear power plants, thermal power plants, solar cells are able to improve energy use efficiency by supplying also the power necessary for reaction and accordingly, the hydrogen energy use efficiency is improved.

Also, in the case of using a generator using a prime mover and the internal combustion engine, the efficiency will improved because of capable of supplying heat and electrical power. In particular, with respect to an internal combustion engine, exhaust gas is a high temperature and the exhaust gas is usable because of including large amount of steam and the exhaust gas may be used to supply heat and water.

When using combination of an internal combustion engine such as a prime mover with the hydrogen generator, although it is capable of using hydrogen directly as a fuel of the internal combustion engine. Even if combining hydrogen with fossil fuel, the combustion efficiency of the fossil fuel is significantly improved. Moreover, when using the oxygen generated at the cathode together with the hydrogen for the internal combustion engine or boiler, its combustion efficiency further increases.

When combining an internal combustion engine with the organic hydride reactor, the engine can be combined with a dehydrogenation reactor and only the hydrogen is used as fuels. By recovering and storing the organic hydride after use and generated water, by only supplying the electric power, the internal combustion engine system is able to be completed, which available to use almost eternally. Such internal combustion engine system is available as a distributed power source for maintenance free power uniform by combination with a generating motor. Furthermore, by combining the solar cell and wind power generator and non-used power storage, it is available to cope with the power consumption in the high load corresponding to the solar cells and wind power generators.

In addition, the hydrogen generator/organic hydride reactor of the embodiment is able to be available as fuel cells, too. Therefore, by combining it with a storage apparatus, it is capable of being used as a power standardization distributed power source which generates an electric power using hydrogen and organic hydride produced with the system electric source.

The hydrogen generator/organic hydride reactor of the embodiment may be miniaturized and mounted on the automobiles because of being less efficiency variations when changing the size, and existing no moving part itself.

In the case of the organic hydride reactor mounted on a car, for example, organic hydride-waste liquid, which is generated by releasing hydrogen from the organic hydride, and steam in the exhaust gas can be stored in a car-mounted reservoir; and after retuned to home by the car, provided that the electro power is supplied to the organic hydride reactor from the system power source, plug-in automobile system, which reuses the waste liquid as organic hydride fuel for the reactor. When water is supplied to the reactor at the time of when the system electric power is supplied to the reactor, there is no need to store the steam included in the exhaust gas, thereby weight of the automobile may be decreased. Also, when using a solar cell or a wind power generator to supply the electric power to the reactor, it is possible realize zero emission-automobile which discharge no hydroxide. In addition, it is capable of using organic hydride fuel as fuel cell and at low fuel combustion efficiency operation when continues to be low speed and frequent stop and go, and the hybrid automobile can be operated by a fuel cell power.

In the example of the hydrogen generator, at low fuel combustion efficiency state where the car with the hydrogen generator is operated in low speed, or stop and go operations are repeated, provided that water included in the exhaust gas is electrolyzed by battery power, the resulting hydrogen and oxygen can be supplied to the internal combustion engine. Thereby, the fuel efficiency of the automobiles may be improved. In the case of using a lead battery or nickel secondary battery as a battery, provided that the hydrogen generator is used collaborating with liquid electrolyte of the battery, hydrogen and oxygen are able to be supplied even if the steam included in the exhaust gas is a little.

Hereinafter, the best mode to practice the present invention will be explained according to the concrete examples of the embodiment. However, the present invention is not limited to the embodiment and examples.

### EXAMPLE 1

FIG. 1 is a schematic view showing a hydrogen generator of the example 1. A hydrogen generator 1000 has a anode 1001, a cathode 1002 and a liquid electrolyte chamber 1003. The anode 1001 and cathode 1002 are opposed to each other and the liquid electrolyte chamber 1003 is positioned between them. The electric power necessary for electrolyzing the liquid electrolyte is supplied from a DC power source 1006. Each of the anode and cathode has a gas-fluid separation function. The hydrogen produced by electrolysis at the anode 1001 is discharged to a hydrogen chamber 1004. On the other hand, oxygen produced at the cathode 1002 is discharged to the oxygen chamber 1005. The hydrogen and oxygen are supplied to an external device or engine. No bubbles adhere to the surface of the anode and cathode in the hydrogen generator. Therefore, it is capable of realizing high current density over 1 A/cm².

Each of the anode and cathode has three layer structure of hydrophilic layer, catalyst layer and hydrophobic layer and the present embodiment uses the carbon paper made by Toyo Rayon Company as a hydrophobic layer. The anode uses nickel mesh with porous nickel plating and the cathode uses a porous silver plated nickel mesh as respective catalyst layers. As the hydrophilic layer, surface oxidized carbon black was formed on the surface of each of the anode and cathode using imidazolium polymer binder. Thirty weight % of potassium hydroxide solution was used as the liquid electrolyte at the room temperature. When supplying electric power from a DC power source, the electrolysis generated and hydrogen and oxygen are obtained, respectively. Maximum current density was 0.8 A/cm². No bubbles stuck to its surface were confirmed.

Furthermore, a liquid electrolyte of 75 weight % potassium hydroxide solution was electrolyzed at 250 degree C. and 5 atm in the present embodiment. The hydrophobic layer and catalyst layer have the same chamber-temperature as each other and the hydrophilic layer is manufactured through laminating surface oxide carbon paper and titan mesh. When DC power source is supplied, electrolysis causes, and hydrogen and oxygen can be generated respectively. The maximum current density was 1.0 A/cm². No bubbles are confirmed on the surface of the poles.

### EXAMPLE 2

In this example, a hydrogenation catalyst layer is formed on the surface of carbon paper-hydrophobic layer of the anode shown in the example 1. Pt fine particles supported with carbon black carriers are used as a catalyst. The diameter of each Pt fine particle is about 4 nano-meters. On the condition that the electrolysis reaction aggresses at 250 degree, 5 atm, when flowing the benzene through the hydrogen chamber 1004, methylcyclohexane is caused and it is confirmed to perform hydrogen producing and hydrogenating to the organic compound in the reactor.

### EXAMPLE 3

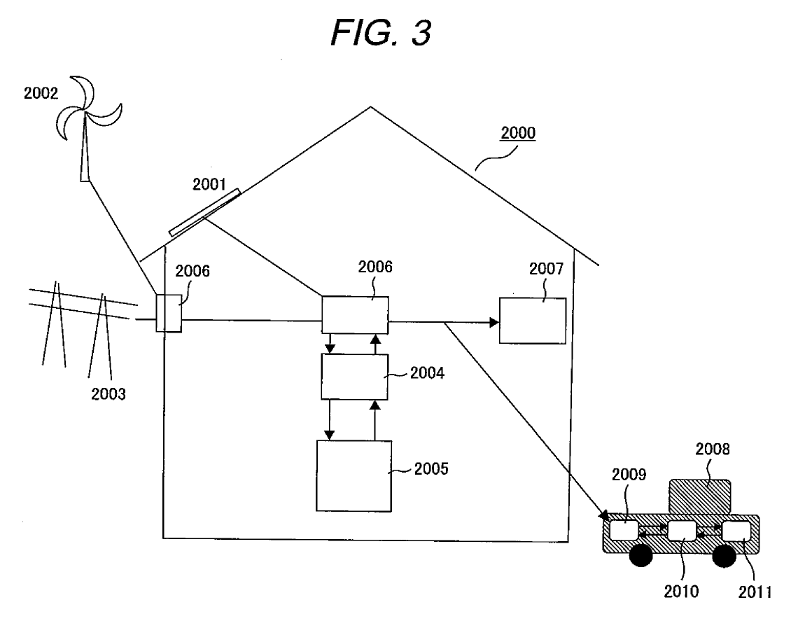

FIG. 3 is a schematic view showing a hydrogen storage and supply system for home use-distributed power source and a hydrogen use-automobile with the system power source and reproducible energy in accordance with the example. An organic hydride reactor of this example functions as a part of this system. The house 2000 has a natural energy power from a solar cell 2001 and wind power generator system, system electric power 2003, a hydrogen or organic hydride reactor 2004, and a hydrogen or organic hydride storage apparatus 2005.

Also, an automobile 2008a by the example mounts a hydrogen generator or organic hydride reactor 2009, a hydrogen or organic hydride storage apparatus 2010, and a reactor 2011. The electric power made by the solar cell 2001 and the wind power generator 2002 which are reproducible power is converted to AC current by way of an inverter 2006. The converted electrical power is used in home use-electric appliances 2007 or the converted electric power is supplied to the hydrogen or organic hydride reactor 2004 when excess power is caused without being used.

The hydrogen or organic hydride reactor 2004 generates hydrogen and oxygen by electrolysis of water. The generated hydrogen is stored with the hydrogen or organic hydride storage apparatus 2005 or is dissipated through the hydrogenation reaction in the apparatus for the manufacturing organic hydride.

The electric power is classified into a peak power corresponding to daytime load changes and a base electric power supplying constant base power through a whole day. The generating system supplying the peak power corresponding to the daytime load changes uses of the system power such as electric power from the electric power company 2003 as the base power. To decrease carbon dioxides, the system electric power 2003 is preferable to use reproducible energy. Except the solar cell power generation, many other producible energy systems, such as window power, underground heat, wave power, ocean temperature difference and biomass are available. While the solar light is able to generate electric power during only daytime, other reproducible energies may generate during night. The thermal power plants temporarily stops its operation to save its fuel expenses because necessary consumed power is abruptly reduced in the night compared with the daytime. On the contrary, the reproducible energies is low cost and there are no problems to supply electric power in the night, if possible to generate the electric power.

Accordingly, this excess power increased in the night is used to manufacture the hydrogen or organic hydride by electrolyzing the water and store them. The organic hydride reactor 2004 may be used as a fuel cell, and therefore the stored hydrogen or organic hydride is supplied to a generator to obtain electric power, too.

An automobile 2008 obtains powering force through burning the hydrogen taken out from the organic hydride fuel by a reactor 2011 within a fuel cell or an internal combustion engine. A hydrogen or organic hydride reactor 2009 mounted on the automobiles in the example hydrogenates the dissipated organic hydride by obtaining the electric power from an inverter 2006 of the house 2000 and reuses as fuels.

What is claimed is:

1. An organic hydride reactor for generating hydrogen by electrolysis of an electrolyte and producing organic hydride from the generated hydrogen, comprising
an anode and a cathode for electrolysis,
said electrolyte applied between said anode and cathode, and
a hydrogenation catalyst for performing a hydrogenation reaction between the hydrogen supplied by electrolysis from said anode and an organic compound,
wherein said anode and cathode have a gas-fluid separation function,
wherein said electrolyte is supplied to only one surface of said anode and cathode, and
gases generated by said electrolysis are discharged from surfaces of said anode and cathode which are not in contact with said electrolyte.

2. The organic hydride reactor according to claim 1, wherein said anode and cathode have the gas-fluid separation function and is constituted by three layers of a hydrophilic layer, catalyst layer and hydrophobic layer.

3. The organic hydride reactor according to claim 1, wherein said electrolyte is a solution and includes potassium hydroxide or sodium hydroxide by 10-90 weight %.

4. The organic hydride reactor according to claim 1,
wherein operation temperature of said reactor is 100-400 degree C.

5. The organic hydride reactor according to claim 1, wherein the pressure inside of said reactor is maintained at a pressure of 1 to 30 atm during operation of said reactor.

6. The organic hydride reactor according to claim 1, wherein said hydrogenation catalyst is formed on the surface which where hydrogen of said anode is discharged.

7. The organic hydride reactor according to claim 1, wherein said organic compound is an aromatic compound which chemically repeats storing and discharging the hydrogen.

8. The organic hydride reactor according to claim 7, said aromatic compound is at least one selected from acetone, benzene, toluene, xylene, mesitylene, naphthalene, methyl naphthalene, anthracene, biphenyl, phenanthrene and combination of their alkyl substitutional products.

9. A distributed power source comprising said organic hydride reactor according to claim 1, a fuel cell, a turbine and a generator or prime mover depending on an engine.

10. The distributed power source comprising according to claim 9,
wherein said organic hydride reactor utilizes waste heat from said generator or prime mover for its operation.

11. A distributed power source comprising said organic hydride reactor according to claim 1 and configuring to produce organic hydride by system power and generate electric power by use of organic hydride or hydrogen stored in said organic hydride.

12. An automobile comprising said organic hydride reactor according to claim 1, a fuel cell, a gas turbine and a generator or prime mover depending on an internal combustion engine.

13. The automobile according to claim 12,
wherein said organic hydride reactor utilizes waste heats from said generator or prime mover and said internal combustion engine for its operation.

14. The organic hydride reactor according to claim 1,
wherein said electrolyte is water derived from combustion of an internal combustion engine.

15. The organic hydride reactor according to claim 14,
wherein oxygen generated from said cathode is supplied to said engine.

16. A hydrogen generator for generating hydrogen by electrolysis of an electrolyte, comprising:
an anode and a cathode for electrolysis;
said electrolyte applied between said anode and cathode; an anode and a cathode for electrolysis,
wherein each of said anode and cathode has a surface being in contact with said electrolyte and a surface being exposed in gaseous atmosphere, and has a gas-fluid separation function, and
wherein gases generated by said electrolysis are supplied from said another surfaces being exposed in gaseous atmosphere to respective targets.
